(19) United States
(12) Patent Application Publication
(10) Pub. No.: US 2011/0122079 A1
(43) Pub. Date: May 26, 2011

(54) TOUCHSCREEN AND DRIVING METHOD THEREOF

(75) Inventors: PO-SHENG SHIH, Miao-Li County (TW); CHIH-HAN CHAO, Miao-Li County (TW); PO-YANG CHEN, Miao-Li County (TW)

(73) Assignee: CHIMEI INNOLUX CORPORATION, Miao-Li County (TW)

(21) Appl. No.: 12/949,805

(22) Filed: Nov. 19, 2010

(30) Foreign Application Priority Data
Nov. 24, 2009 (TW) 98139847

(51) Int. Cl. G06F 3/041

(52) U.S. Cl. 345/173

(57) ABSTRACT

A touchscreen includes a touch panel including a plurality of sensor electrodes, a drive circuit including a plurality of the first transistors respectively corresponding to the sensor electrodes. The drive circuit is configured for detecting voltage on the sensor electrodes. When the touchscreen is initializing, a first voltage is provided to pre-charge the sensor electrodes, and a second voltage is provided to further charge the sensor electrodes via each first transistor. In addition, the first voltage and a voltage difference formed between the first and the second voltage are both less than or about equal to the source-drain withstanding voltage of each first transistor.

### BACKGROUND

1. Technical Field

The present disclosure generally relates to touch input technology, and particularly to a touchscreen and a method for driving the touchscreen.

2. Description of Related Art

With the development of display and multimedia technologies, input devices such as keyboards, mice, and remote controls barely meet user demands. As portable electronic devices become more widely used, a user-friendly, simplified and convenient operation of an input device is increasingly important. Touchscreen input devices can handily meet many of such user demands.

A commonly used touchscreen includes a touch panel and a drive circuit for driving the touch panel. An external power supply may be used to provide a voltage to the drive circuit. In operation, contact with the touchscreen surface, is detected by the drive circuit.

The drive circuit may be a highly integrated circuit with numerous transistors. The operating voltage of the transistors in the drive circuit may be a low voltage, such as in a range from negative 3.3V to positive 3.3V. However, the voltage provided by the external power supply may be a high voltage exceeding the operating voltage of the transistors, such as 5V. Damage to the transistors is likely at such high voltages.

What is called for, then, is a touchscreen and driving method thereof which can overcome the described limitations.

### SUMMARY

An aspect of the disclosure relates to a touchscreen including a touch panel including a plurality of sensor electrodes for sensing a contact position on the touch panel; and a drive circuit including a plurality of the first transistors respectively corresponding to the sensor electrodes and configured for detecting voltage on the sensor electrodes. When the touchscreen is initializing, a first voltage is provided to pre-charge the sensor electrodes, and a second voltage is provided to further charge the sensor electrodes via each first transistor, and the first voltage and a voltage difference formed between the first and the second voltage are both less than or about equal to a source-drain withstanding voltage of each first transistor.

An aspect of the disclosure relates to a method for driving a touchscreen, the touchscreen comprising a touch panel and a drive circuit, the touch panel comprising a plurality of sensor electrodes, the drive circuit comprising a plurality of first transistors respectively corresponding to the sensor electrodes, the method for driving the touchscreen to initialize including providing a first voltage to pre-charge the sensor electrodes; and providing a second voltage to further charge the sensor electrodes via each first transistor. The first voltage and a voltage difference formed between the first and the second voltage are both less than or about equal to the source-drain withstanding voltage of the first transistors.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is a schematic structural view of one embodiment of a touchscreen of the present disclosure, the touchscreen including a touch panel and a drive circuit.

FIG. 2 is a cross-section of part of the touch panel of FIG. 1, the touch panel including a first conductive coating and a second conductive coating.

FIG. 3 is an isometric, schematic plan view of the first conductive coating of FIG. 2.

FIG. 4 is an isometric, schematic plan view of the second conductive coating of FIG. 2.

FIG. 5 is a schematic circuit connection diagram of the second conductive coating of FIG. 2 and the drive circuit of FIG. 1.

### DETAILED DESCRIPTION

Reference will now be made to the drawings to describe embodiments in detail.

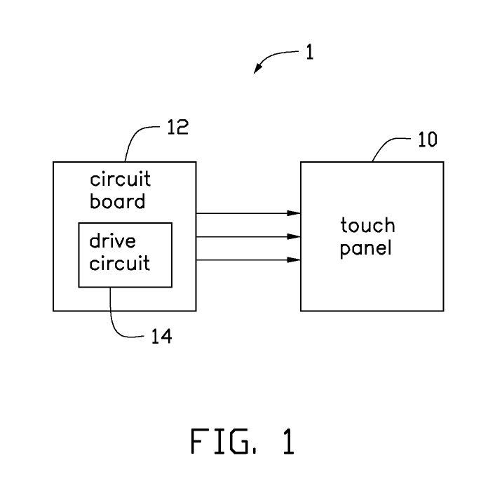

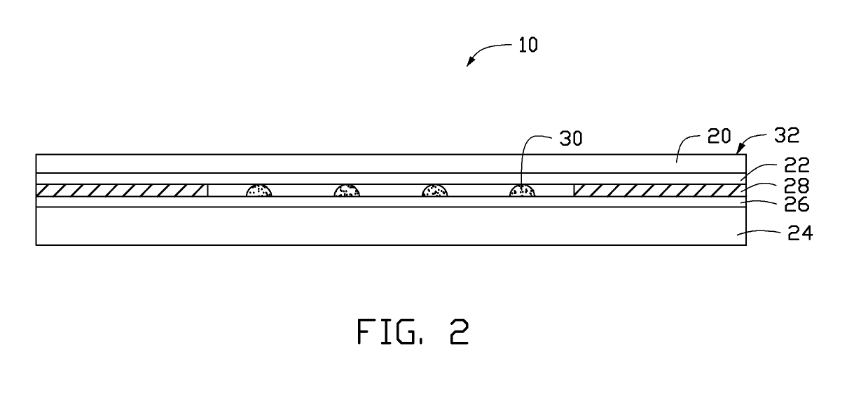

Referring to FIG. 1, one embodiment of a touchscreen 1 that includes a touch panel 10, a circuit board 12, and a drive circuit 14. The touch panel 10 may be used as an input interface. The drive circuit 14 is mounted on the circuit board 12 and electrically connected to the touch panel 10 via the circuit board 12. The touch panel provides an input plane 32 (shown in FIG. 2) for user operations. The drive circuit 14 detects contact positions corresponding to the user operations.

Referring to FIG. 2, the touch panel 10 includes a first substrate 20, a second substrate 24 opposite to the first substrate 20, and a first conductive coating 22, a second conductive coating 26, an adhesive layer 28, and a plurality of spacers 30 sandwiched between the first substrate 20 and the second substrate 24. An outer surface of the first substrate 20, separated from the second substrate 24, defines the input plane 32. The first and the second conductive coatings 22, 26 are respectively disposed on inner surfaces of the first and the second substrates 20, 24. The spacers 30 are located between the first and the second conductive coatings 22, 26, spacing the first and the second conductive coatings 22, 26, and avoiding electrical connection between the first and the second conductive coatings 22, 26 until the touch panel 10 is contacted. The adhesive layer 28 is disposed between the first and the second conductive coatings 22, 26 and corresponding to a peripheral area of the first and the second substrates 20, 24 to secure the first and the second substrates 20, 24 together.

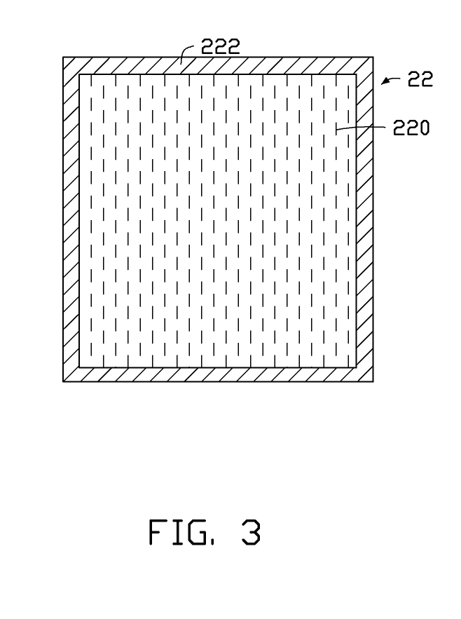

Referring to FIG. 3, the first conductive coating 22 includes a first transparent conductive layer 220 and an electrode 222. The first transparent conductive layer 220 may be a rectangular film and can, for example, be made of indium-tin oxide (ITO) or similar transparent conductive material. The electrode 222 may be continuously disposed at a peripheral area of the first transparent conductive layer 220, connecting with the first transparent conductive layer 220 electrically.

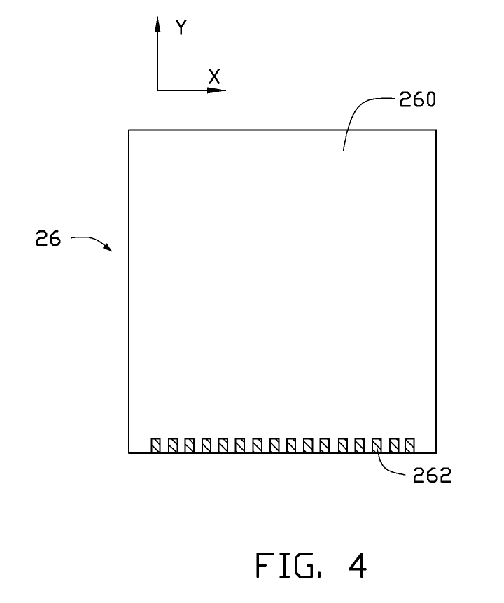

Referring to FIG. 4, the second conductive coating 26 includes a second transparent conductive layer 260 and a plurality of sensor electrodes 262 (from a first sensor electrode to an n-th sensor electrode). The sensor electrodes 262 are uniformly disposed on an edge of the second transparent conductive layer 260 along a first axis X, connecting with the second transparent conductive layer 260 electrically. The second transparent conductive layer 260 may be a resistance-type anisotropic conductive film, and can, for example, be made from a carbon nanotube film with uniform thickness. The carbon nanotube film is a layered structure formed by a plurality of ordered carbon nanotubes. The carbon nanotubes are uniformly arranged along the first axis X, with extension of the axis of each carbon nanotube parallel with a second axis Y. The second axis Y is perpendicular to the first axis X. Therefore, the resistance of the second transparent conductive layer 260 along the first axis X exceeds that of the second axis Y. Since the resistance anisotropy of the carbon nanotube film, the second transparent conductive layer 260 is divided into a plurality of conductive channels along the first axis X corresponding to the sensor electrodes 262. A voltage of the sensor electrode 262 corresponding to a contact position is different from the voltage of other sensor electrodes 262.

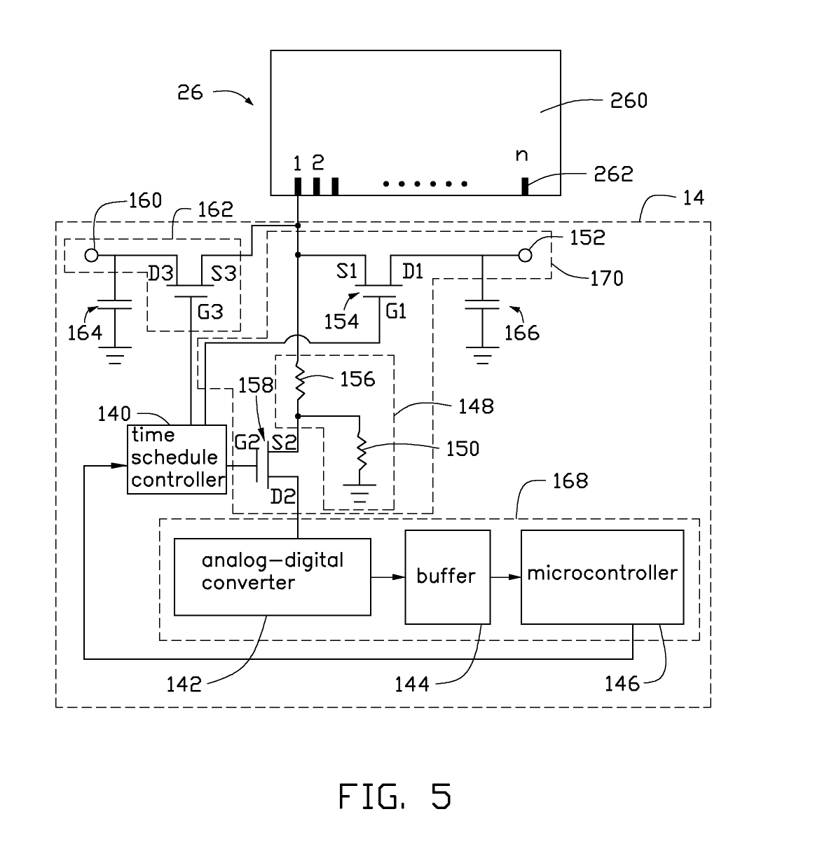

Referring to FIG. 5, the drive circuit 14 includes a processing circuit 168, a time schedule controller 140, a plurality of detection units 170, and an auxiliary circuit 162. Each detection unit 170 connects with one corresponding sensor electrode 262, and is configured for detecting the voltage thereon. For simplicity, only the first sensor electrode 262 connecting with the detection unit 170 is shown in FIG. 5. The time schedule controller 140 connects with and controls each detection unit 170. The processing circuit 168 is used to confirm the contact position according to voltage output by the detection units 170. The auxiliary circuit 162 is used to pre-charge the sensor electrodes 262.

Each detection unit 170 includes a first transistor 154, a second transistor 158 and a step-down circuit 148. The step-down circuit 148 includes a first resistor 156 and a second resistor 150. The first transistor 154 includes a source electrode S1, a gate electrode G1 and a drain electrode D1. The second transistor 158 includes a source electrode S2, a gate electrode G2, and a drain electrode D2. The drain electrode D1 connects with a second input terminal 152. The source electrode S1 connects with a corresponding sensor electrode 262. The gate electrode G1 connects with the time schedule controller 140. The first resistor 156 is connected between the sensor electrode 262 and the source electrode S2. The second resistor 150 is connected between the source electrode S2 and the ground. The gate electrode G2 connects with the time schedule controller 140 and the drain electrode D2 connects with the analog-digital converter 142. The step-down circuit 148 is used to prevent the second transistor 158 from burning out by sharing a portion of the voltage of the sensor electrode 262, with the first and the second resistors 156, 150 appropriately selected.

The auxiliary circuit 162 includes a third transistor. The third transistor includes a source electrode S3, a gate electrode G3 and a drain electrode D3. The source electrode S3 connects with each sensor electrode 262. The gate electrode G3 connects with the time schedule controller 140. The drain electrode D3 connects with a first input terminal 160.

The processing circuit 168 includes an analog-digital converter 142, a buffer 144, and a microcontroller 146, which are connected sequentially. The microcontroller 146 connects with the time schedule controller 140. The voltage output by the detection units 170 are analog voltage. The analog-digital converter 142 is used to receive the analog voltage, and convert the analog voltage into a corresponding digital voltage. The buffer 144 is used to store the digital voltage output by the analog-digital converter 142. The microcontroller 146 is used to control the time schedule controller 140 and compares the digital voltage received from the buffer 144, to acquire the coordinates of the contact position.

Absolute values of voltage differences formed between the source electrode S1 and the drain electrode D1, between the source electrode S2 and the drain electrode D2, and between the source electrode S3 and the drain electrode D3 are required not to be more than a specified value, and the specified value is defined as a source-drain withstanding voltage γ. Otherwise, the first transistor 154, the second transistor 158 and the third transistor are apt to burn out. The source-drain withstanding voltage γ can, for example, be 3.3V.

In initialization, a first voltage is provided by a first external power supply to charge each sensor electrode 262, and a second voltage is then provided by a second external power supply to further charge each sensor electrode 262 when voltage on the sensor electrodes 262 are about equal to the first voltage. Neither the first voltage nor a voltage difference formed between the first and the second voltage exceed γ. Therefore, the first, the second and the third transistors 154, 158 can be prevented from burning out.

In operation, the sensor electrodes 262 are sequentially scanned under control of the time schedule controller 140, such that the voltage of each sensor electrode 262 are sequentially applied to the processing circuit 168 via the detection units 170. The first voltage can, for example, be 3.3V. The second voltage can, for example, be 5V.

Also referring to FIGS. 2-5, a detailed description of the exemplary method for driving the touchscreen 1 follows.

The touchscreen 1 starts to initialize. A first external power supply provides a first voltage to the drive circuit 14 via the first input terminal 160, and a second external power supply provides a second voltage to the drive circuit 14 via the second input terminal 152 synchronously. The first voltage is not more than γ, nor is a voltage difference formed between the second voltage and the first voltage. The time schedule controller 140 outputs control signals under control of the microcontroller 146, switching the third transistor on and the first transistors 154 and the second transistors 158 of all of the detection units 170 off. Accordingly, the first voltage can be applied to the sensor electrodes 262 via the drain electrode D3 and the source electrode S3, to pre-charge the sensor electrodes 262. Since the first voltage is not more than γ, the voltage differences applied between the drain electrode D3 and the source electrode S3 of the third transistor and between the drain electrode D1 and the source electrode 51 of each first transistor 154 are not more than γ. Therefore, the third and the first transistors 154 can be prevented from burning out at the first stage of charging. In addition, the second transistors 158 can be prevented from burning out because of the step-down circuit 148.

When voltage of the sensor electrodes 262 are about equal to the first voltage, the third transistor is then switched off and the first transistors 154 are switched on under control of the time schedule controller 140. Accordingly, the second voltage is then applied to the sensor electrodes 262 via the drain electrodes D1 and source electrodes 51, to continue to charge the sensor electrodes 262 until the voltage of the sensor electrode 262 are about equal to the second voltage. The sensor electrodes 262 are accordingly charged completely, with a voltage of the second transparent conductive layer 260 about equal to the second voltage correspondingly. Since the first and the second external power supplies provide the first and the second voltage to the drive circuit 14 continuously, when the voltage of the sensor electrodes 262 reach the second voltage, the voltage differences formed between the drain electrode D3 and the source electrode S3 of the third transistor and between the drain electrode D1 and the source electrode S1 of each first transistor 154 are not more than γ. Therefore, the third and the first transistors 154 can be prevented from burning out at the second stage of charge. In addition, the second transistors 158 can be prevented from burning out because of the step-down circuit 148.

In addition, the electrode 222 is electrically connected to the ground, that is, a voltage of the first transparent conductive layer 220 can be 0V. Thus, the touchscreen 1 completes initialization.

When the touchscreen 1 begins operation, the first transistor 154 connected to the first sensor electrode 262 is switched off and the second transistor 158 connected to the first sensor electrode 262 is switched on under control of the time schedule controller 140. Accordingly, the voltage of the first sensor electrode 262 is applied to the analog-digital converter 142 via the detection unit 170. The analog-digital converter 142 converts the analog voltage output by the detection unit 170 into a digital voltage and outputs the digital voltage to the buffer 144. The buffer 144 stores the digital voltage, and when the microcontroller 146 reads the digital voltage, the buffer 144 outputs the digital voltage to the microcontroller 146. When the microcontroller 146 reads the digital voltage corresponding to the first sensor electrode 262, the microcontroller 146 also switches the first transistor 154 connecting with the first sensor electrode 262 on, the second transistor 158 connecting with the first sensor electrode 262 off, the first transistor 154 connecting with the second sensor electrode 262 off, and the second transistor 158 connecting with the second sensor electrode 262 on respectively, via the time schedule controller 140 at essentially the same time. Thus, a digital voltage corresponding to the second sensor electrode 262 can be read by the microcontroller 146. In this manner, digital voltage corresponding to the third sensor electrode 262 . . . and the n-th sensor electrode 262 can be sequentially read by the microcontroller 146.

When all the sensor electrodes 262 have been scanned, the microcontroller 146 starts to scan the sensor electrodes 262 from the first to the n-th sequentially again. Accordingly, the sensor electrodes 262 are continually sequentially scanned by the microcontroller 146 when the touchscreen 1 is in operation.

During operation, if the touchscreen 1 is not contacted, the digital voltage read by the microcontroller 146 are equal. If the touchscreen 1 is contacted over the touch panel 10 with a single contact, one digital voltage is smaller than the others read by the microcontroller 146. Accordingly, contact is confirmed. An X-coordinate of a contact position can be obtained by measuring X-coordinate of the sensor electrode output voltage of the contact position. A Y-coordinate of the contact position can be obtained by calculating how much voltage amplitude of the small digital voltage drops, by comparing with voltage amplitude of a digital voltage representative of the second voltage. Thus, a location of the contact position can be confirmed. In addition, the touchscreen 1 can be contacted over the touch panel 10 with multiple contacts. In such case, each contact position can be confirmed in the same way as described in relation to a single touch over the touch panel 10.

Finally, when the first and the second external power supplies cease providing voltage to the drive circuit 14, the touchscreen 1 stops. In addition, the drive circuit 14 further includes a first capacitor 164 connected in parallel with the first external power supply, a second capacitor 166 connected in parallel with the second external power supply. Accordingly, even if the first and the second external power supplies stop providing voltage to the drive circuit 14, and the first and the second capacitors 164, 166 can provide voltage to the drive circuit 14 for a period of time until the charges stored in the sensor electrodes 262 are discharged completely.

When the touchscreen 1 stops working, the microcontroller 146 switches the first and second transistors 154, 158 off and the third transistor on via the time schedule controller 140. The voltage of each sensor electrode 262 can be discharged via the first transistor until the voltage of the sensor electrodes 262 descend to the first voltage. Since the first voltage is not more than γ, voltage difference applied between the drain electrode D3 and the source electrode S3 of the third transistor and between the drain electrode D1 and the source electrode 51 of each first transistor 154 are not more than y. Therefore, the third and the first transistors 154 can be prevented from burning out at current voltage of the sensor electrodes 262. The time schedule controller 140 maintains the third transistor in an on state until the voltage of the sensor electrodes 262, the voltage between the source electrode S3 and the drain electrode D3, the voltage between each source electrode 51 and each drain electrode D1, the voltage between each source electrode S2 and each drain electrode D2 all reach 0V.

As described, since the touchscreen 1 of the present disclosure includes the auxiliary circuit 162 including the third transistor, the sensor electrodes 262 can all be pre-charged to the first voltage by the first external power supply. The touchscreen 1 further includes the step-down circuit 148 connected between each sensor electrode 262 and each second transistor 158. Since the first voltage is not more than γ, voltage difference applied between the drain electrode D3 and the source electrode S3 of the third transistor, between the drain electrode D1 and the source electrode 51 of each first transistor 154 and between the drain electrode D2 and the source electrode S2 of each second transistor 158 are not more than γ. Therefore, the third, the first and the second transistors 154, 158 are protected at this stage. Further, when the second external power supply provides the second voltage (not exceeding the first voltage) to charge the sensor electrodes 262 via the drive circuit 14, the voltage applied between the drain electrode D3 and the source electrode S3 of the third transistor, between the drain electrode D1 and the source electrode 51 of each first transistor 154 are not more than y. Thus, the third and the first transistors 154 are prevented form burning out when the second voltage is applied to the drive circuit 14. Moreover, as long as the first and the second resistors 156, 150 are appropriately selected, the voltage applied between the drain electrode D2 and the source electrode S2 of each second transistor 158 are also not more than γ, accordingly, the second transistors 158 are also prevented from burning out when the second voltage is applied to the drive circuit 14. Therefore, the quality of the touchscreen 1 improves.

It should be pointed out that in alternative embodiments, the buffer 144 can be integrated in the microcontroller 146. The third transistor of the auxiliary circuit 162 can also be replaced by other components or circuits with a switching function. The first and the second resistors 156, 150 of the step-down circuit 148 can be both replaced by dynatrons or the like. In another example, the buffer 144 can be omitted.

It is believed that the present embodiments and their advantages will be understood from the foregoing description, and it will be apparent that various changes may be made thereto without departing from the spirit and scope of the embodiments or sacrificing all of their material advantages.

What is claimed is:

1. A touchscreen, comprising:
a touch panel comprising a plurality of sensor electrodes for sensing a contact position on the touch panel;
a drive circuit comprising a plurality of first transistors respectively corresponding to the sensor electrodes, and configured for detecting voltage on the sensor electrodes;
wherein when the touchscreen is initializing, a first voltage is provided to pre-charge the sensor electrodes, and a second voltage is provided to further charge the sensor electrodes via each first transistor, the first voltage and a voltage difference formed between the first and the second voltage are both less than or about equal to a source-drain withstanding voltage of each first transistor.

2. The touchscreen of claim 1, wherein the drive circuit further comprising an auxiliary circuit for providing the first voltage to the sensor electrodes.

3. The touchscreen of claim 2, wherein the auxiliary circuit comprises a third transistor, and the first voltage, the voltage difference are both less than or about equal to the source-drain withstanding voltage of the third transistor.

4. The touchscreen of claim 2, wherein the drive circuit comprises a plurality of the detection units and a processing circuit respectively connecting with the detection units, wherein the detection units each comprises a first transistor corresponding to a sensor electrode, and configured for detecting the voltage on the corresponding sensor electrode, wherein the processing circuit is configured for confirming the contact position according to voltage output by the detection units.

5. The touchscreen of claim 4, wherein each detection unit further comprises a second transistor, the voltage of each sensor electrode are read by the processing circuit via a corresponding second transistor.

6. The touchscreen of claim 5, wherein each detection unit further comprises a step-down circuit, when the touchscreen is operating, the voltage of each sensor electrode are output to the second transistors via the step-down circuits, and voltage output by the step-down circuits are less than or about equal to the source-drain withstanding voltage of the second transistors.

7. The touchscreen of claim 6, wherein each step-down circuit comprises a first resistor and a second resistor connected in series with the first resistor, one end of the first resistor connecting with the second resistor is connected to the second transistor, the other end of the first resistor is connected to the sensor electrode, one end of the second resistor is connected to the first resistor, and the other end of the second resistor is connected to the ground.

8. The touchscreen of claim 7, wherein the drive circuit further comprises a time schedule controller, when the touchscreen is initializing, the time schedule controller controls the third transistor to be switched on, and the first and the second transistors to be switched off, accordingly, the first voltage is provided to pre-charge the sensor electrodes via the third transistor, when the voltage of the sensor electrodes are about equal to the first voltage, the time schedule controller controls the third transistor to be switched off and the first transistors to be switched on, accordingly, the second voltage is provided to charge the sensor electrodes again via the first transistors, and when the voltage of the sensor electrode are about equal to the second voltage, the touchscreen begins operation.

9. The touchscreen of claim 8, wherein the first voltage is provided by a first external power supply, the second voltage is provided by a second external power supply, and the drive circuit further comprises a first capacitor connected in parallel with the first external power supply, a second capacitor connected in parallel with the second external power supply, when the touchscreen stops working, the time schedule controller controls the first and the second transistors to be switched off, and the third transistor to be switched on, accordingly, the sensor electrodes discharge via the third transistor.

10. The touchscreen of claim 9, wherein the touch panel further comprises a first substrate, a second substrate opposite to the first substrate, and a first conductive coating comprising a first transparent conductive layer, a second conductive coating comprising a second transparent conductive layer and a plurality of sensor electrodes disposed on the second transparent conductive layer along a first axis, the first and the second conductive coatings disposed on inner surfaces of the first and the second substrates respectively, wherein the second conductive coating is made from a carbon nanotube film comprising a plurality of carbon nanotubes arranged along the first axis, with extension of the axis of each carbon nanotube parallel with a second axis perpendicular to the first axis.

11. The touchscreen of claim 10, wherein the processing circuit comprises an analog-digital converter for converting an analog voltage output by each step-down circuit into a digital voltage and a microcontroller connected with the analog-digital converter for comparing the digital voltage output by the analog-digital converter to acquire coordinates of the contact position.

12. The touchscreen of claim 11, wherein the processing circuit further comprises a buffer connected between the analog-digital converter and the microcontroller for storing the digital voltage output by the analog-digital converter and outputting the digital voltage to the microcontroller when the microcontroller reads the digital voltage.

13. A method for driving a touchscreen, the touchscreen comprising a touch panel and a drive circuit, the touch panel comprising a plurality of sensor electrodes, the drive circuit comprising a plurality of the first transistors respectively corresponding to the sensor electrodes, the method for driving the touchscreen to initialize comprising:
providing a first voltage to pre-charge the sensor electrodes; and
providing a second voltage to further charge the sensor electrodes via each first transistor;
wherein the first voltage, a voltage difference formed between the first and the second voltage are both less than or about equal to the source-drain withstanding voltage of the first transistors.

14. The method of claim 13, wherein the drive circuit further comprises an auxiliary circuit, the first voltage is provided to pre-charge the sensor electrodes via the auxiliary circuit.

15. The method of claim 14, wherein the auxiliary circuit comprises a third transistor, the first voltage and the voltage difference are both less than or about equal to the source-drain withstanding voltage of the third transistor.

16. The method of claim 15, further comprising:
scanning the sensor electrodes and outputting scan voltage corresponding to the voltage on the sensor electrodes;
confirming a contact position on the touch panel according to the scan voltage.

17. The method of claim 16, wherein the drive circuit further comprises a plurality of detection units and a processing circuit connected to the detection units, each detection unit is connected to a corresponding sensor electrode, wherein the detection units are configured for scanning the sensor electrodes and outputting scan voltage corresponding to the voltage on the sensor electrodes, and the processing circuit is configured for confirming a contact position on the touch panel according to the scan voltage output by the detection units.

18. The method of claim 17, wherein each detection unit comprises a second transistor, the voltage of the sensor electrodes are provided to the processing circuit via each second transistor.

19. The method of claim 18, wherein each detection unit further comprises a step-down circuit, when the touchscreen is working, the voltage of each sensor electrode are output to the second transistors via the step-down circuit, and voltage output by the step-down circuits are less than or about equal to the source-drain withstanding voltage of the second transistors.

20. The method of claim 19, wherein the touch panel further comprises a first substrate, a second substrate opposite to the first substrate, and a first conductive coating comprising a first transparent conductive layer, a second conductive coating comprising a second transparent conductive layer and a plurality of sensor electrodes disposed on the second transparent conductive layer along a first axis, the first and the second conductive coatings disposed on inner surfaces of the first and the second substrates respectively, wherein the second conductive coating is made from a carbon nanotube film comprising a plurality of carbon nanotubes arranged along the first axis, with extension of the axis of each carbon nanotube parallel with a second axis perpendicular to the first axis.
